(19) United States
(12) Patent Application Publication
(10) Pub. No.: US 2026/0093017 A1
(43) Pub. Date: Apr. 2, 2026

(54) PHOTODETECTION DEVICE

(71) Applicant: Sony Semiconductor Solutions Corporation, Atsugi-shi, Kanagawa (JP)

(72) Inventors: Hiroyasu ISHII, Kanagawa (JP); Yusuke MORIYAMA, Kanagawa (JP); Tomohiro BABA, Kanagawa (JP); Nobuaki KAJI, Kanagawa (JP); Kazuyuki WAKAYAMA, Kanagawa (JP); Kunihiko IZUHARA, Kanagawa (JP)

(73) Assignee: Sony Semiconductor Solutions Corporation, Atsugi-shi, Kanagawa (JP)

(21) Appl. No.: 19/112,978

(22) PCT Filed: Aug. 18, 2023
(86) PCT No.: PCT/JP2023/029830

§ 371 Date: Mar. 19, 2025

(30) Foreign Application Priority Data
Oct. 4, 2022 (JP) 2022-160498

(51) Int. Cl. G01S 7/4863; G01S 7/481; G01S 17/10

(52) U.S. Cl. CPC G01S 7/4863; G01S 7/4815; G01S 17/10

(57) ABSTRACT

A device capable of improving characteristics of a light sensor by applying an appropriate bias voltage to the light sensor. A device according to one embodiment includes a first light source configured to emit a first light, a second light source configured to emit a second light having a first characteristic different from a second characteristic of the first light, a first light sensor configured to detect first reflected light that is the first light emitted from the first light source and reflected by an object, and a second light sensor configured to detect second reflected light that is the second light emitted from the second light source and reflected by a first member that is distinct from the object.

### CROSS REFERENCE TO RELATED APPLICATIONS

This application claims the benefit of Japanese Priority Patent Application JP 2022-160498 filed on Oct. 4, 2022, the entire contents of which are incorporated herein by reference.

### TECHNICAL FIELD

The present disclosure relates to a photodetection device.

### BACKGROUND ART

In a photodetection device having a distance measurement function such as time of flight (ToF), reflected light from an object is often detected using a photosensor such as a single-photon avalanche diode (SPAD). When a bias voltage applied to the photosensor is not appropriate, characteristics deteriorate, leading to a decrease in sensitivity or an increase in dark current. Hence it is necessary to appropriately adjust the bias voltage to be applied to the photosensor.

### CITATION LIST

### Patent Literature

PTL 1: JP 2021-056016A
PTL 2: JP 2019-132640A

### SUMMARY

### Technical Problem

Provided is a photodetection device capable of improving characteristics of a photosensor by applying an appropriate bias voltage to the photosensor.

### Solution to Problem

A device according to one aspect of the present disclosure includes: a first light source configured to emit a first light, a second light source configured to emit a second light having a first characteristic different from a second characteristic of the first light, a first light sensor configured to detect first reflected light that is the first light emitted from the first light source and reflected by an object, and a second light sensor configured to detect second reflected light that is the second light emitted from the second light source and reflected by a first member that is distinct from the object.

The first characteristic of the second light is a first wavelength, the second characteristic is a second wavelength, and the first wavelength is different from the second wavelength.

The first light source is a vertical-cavity surface-emitting laser (VCSEL), and the second light source is a light-emitting diode (LED).

Drive signals of the first light source and the second light source are activated at different timings.

The device further includes:
a first pixel circuit configured to convert a first pixel signal of a pixel in the first light sensor into a digital signal based on the first pixel signal, and a second pixel circuit configured to hold a voltage value of a second pixel signal of a pixel in the second light sensor, and output the voltage value of the second pixel signal as an analog signal.

The device further includes a controller configured to apply a bias voltage to the first light sensor in response to detecting the first reflected light, the bias voltage based on the analog signal.

The first light source and the second light source are configured to alternately emit the first light and the second light, and the controller is configured to apply the bias voltage when the first reflected light is next detected.

The digital signal is output during a period of time, and the controller is configured to apply the bias voltage during the period of time.

The controller is configured to apply the bias voltage when the first reflected light is next detected, after the first light source emits the first light and before the second light source emits the second light.

The first light source and the second light source emit the first light and the second light simultaneously.

The controller is configured to apply the bias voltage when the first reflected light is detected, after the second light source emits the second light and before the first light source emits the first light.

The device further includes a filter configured to allow the first reflected light in a predetermined frequency band to pass through the filter, the first member is the filter.

A first transmittance of the first light through the filter is higher than a second transmittance of the second light through the filter, and a first reflectance of the first light from the filter is lower than a second reflectance of the second light from the filter.

The first light sensor and the second light sensor are disposed on one semiconductor chip.

The device further includes a wall between the first light source and the second light source and the wall shields the first light source from the second light emitted by the second light source.

The first light sensor and the second light sensor are disposed on one semiconductor chip, and the wall is disposed separately from the one semiconductor chip.

A digital signal based on the first pixel signal is used to measure a distance from the first light sensor to the object.

A device comprising:
a first light source configured to emit a first light;
a second light source configured to emit a second light having a first characteristic different from a second characteristic of the first light;
a first light sensor configured to detect first reflected light of the first light emitted from the first light source;
a second light sensor configured to detect second reflected light of the second light emitted from the second light source; and
a controller configured to apply a bias voltage to the first light sensor when the first reflected light is detected, on a basis of a voltage value of a second pixel signal from the second light sensor.

The device further includes:
a first pixel circuit configured to convert a first pixel signal of the first light sensor into a digital signal; and
a second pixel circuit configured to hold the voltage value of the second pixel signal of the second light sensor, and output the voltage value of the second pixel signal as an analog signal.

The second light sensor is configured to detect the second reflected light that is the second light reflected by a first fixed member.

In the first fixed member, a first transmittance of the first light is higher than a second transmittance of the second light, and a first reflectance of the first light is lower than a second reflectance of the second light.

The device further includes a wall that is disposed between the first light source and the second light source, wherein the wall shields the first light source from the second light of the second light source.

The first light sensor and the second light sensor are disposed on one semiconductor chip, and the wall is disposed separately from the one semiconductor chip.

The digital signal based on the first pixel signal is used to measure a distance from the first light sensor to an object.

### BRIEF DESCRIPTION OF DRAWINGS

FIG. 1 illustrates a configuration example of an electronic device according to a first embodiment.

FIG. 2 is a cross-sectional view illustrating a configuration example of a distance measuring module.

FIG. 3 is a plan view illustrating the configuration example of the distance measuring module.

FIG. 4 is a schematic diagram illustrating an example of a chip configuration of a distance measuring sensor.

FIG. 5 is a plan view illustrating a configuration example of a light receiver.

FIG. 6 is a block diagram illustrating a configuration example of a light receiver and a sensor control circuit.

FIG. 7 is a block diagram illustrating a configuration example of a timing detection circuit and a sample-and-hold circuit.

FIG. 8 is a timing diagram illustrating an example of an operation of a distance measuring module according to the first embodiment.

FIG. 9 is a timing diagram illustrating an example of an operation of a distance measuring module according to a second embodiment.

FIG. 10 is a timing diagram illustrating an example of an operation of a distance measuring module according to a third embodiment.

FIG. 11 is a plan view illustrating a configuration example of a distance measuring module according to a fourth embodiment.

FIG. 12 is a graph illustrating an example of characteristics of an optical filter.

FIG. 13 is a circuit diagram illustrating a configuration example of a part of a sensor control circuit according to a sixth embodiment.

FIG. 14 is a block diagram illustrating an example of a schematic configuration of a vehicle control system that is an example of a mobile structure control system.

FIG. 15 is a diagram illustrating an example of an installation position of an imaging part.

### DESCRIPTION OF EMBODIMENTS

Hereinafter, specific embodiments to which the present technology is applied will be described in detail with reference to the drawings. The drawings are schematic or conceptual, and the ratio of each portion and the like are not necessarily the same as actual ones. In the specification and the drawings, similar elements as those described above concerning the previously described drawings are denoted by the same reference signs, and the detailed description thereof is appropriately omitted.

### First Embodiment

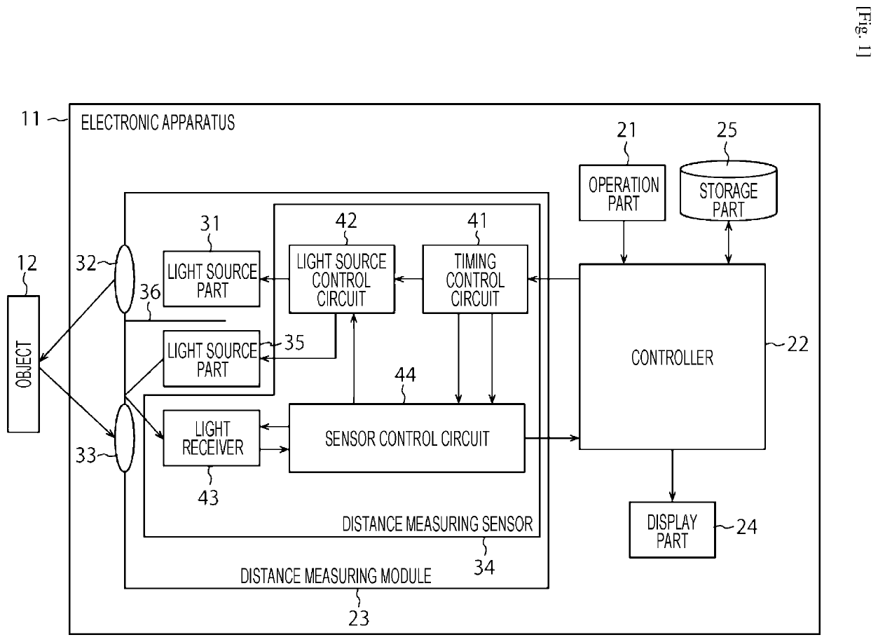

FIG. 1 is a diagram illustrating a configuration example of an electronic device 11 according to a first embodiment. The electronic device 11 is an electronic device having a distance measurement function of measuring a distance to an object 12 to be measured using the ToF method. For example, the electronic device 11 may include only the distance measurement function or may include other functions. The electronic device 11 is, for example, an electronic device such as a smartphone, a mobile phone, a digital camera, or an automobile.

The electronic device 11 includes an operation part 21, a controller 22, a distance measuring module 23, a display part 24, and a storage part 25.

The operation part 21 includes, for example, various operation devices for operating the electronic device 11 such as a switch, a button, a keyboard, and a touch panel. The operation part 21 supplies an operation signal indicating the operation content to the controller 22.

The controller 22 includes a processor such as a central processing unit (CPU). The controller 22, for example, controls each part of the electronic device 11 on the basis of an operation signal from the operation part 21, or executes a program stored in the storage part 25 to perform predetermined processing. For example, the controller 22 performs processing based on the measurement result of the distance measuring module 23.

The distance measuring module 23 is a module that measures the distance to the object 12. The distance measuring module 23 includes a light source part 31, a light source lens 32, an imaging lens 33, and a distance measuring sensor 34. The object 12 is any object outside the electronic device 11.

The light source part 31 as a first light source emits emitted light as first light, which is pulsed light, under the control of a light source control circuit 42 of the distance measuring sensor 34. The emitted light is transmitted through the light source lens 32, and the object 12 is irradiated with the emitted light. The reflected light as first reflected light reflected by the object 12 passes through the imaging lens 33 and enters a light receiver 43. Meanwhile, the light source part 31 is optically shielded from a light source part 35 and the light receiver 43 by a light-shielding wall 36. Therefore, the irradiation light from the light source part 31 is not reflected inside the housing of the distance measuring module 23 or does not directly enter the light receiver 43. The light source part 31 has, for example, a vertical-cavity surface-emitting laser (VCSEL) structure, and emits laser light as emitted light. The wavelength of the emitted light from the light source part 31 is arbitrarily selected according to the application of the distance measuring module 23, but is preferably a wavelength at which the light is sufficiently transmitted through the light source lens 32.

The light source lens 32 is a lens provided at a position facing the light-emitting surface of the light source part 31, transmits the emitted light from the light source part 31, and is used for shaping the emitted light and the like.

The imaging lens 33 is a lens provided at a position facing the light-receiving surface of the light receiver 43, transmits reflected light from the object 12, and forms an image of the object 12 on the light-receiving surface of the light receiver 43 using the reflected light.

The light source part 35 as the second light source emits pulsed emitted light under the control of the light source control circuit 42. A member inside the housing of the distance measuring module 23 is irradiated with the emitted light from the light source part 35, and the reflected light as second reflected light reflected by the member enters the light receiver 43. The light source part 35 is shielded from the light source part 31 by the light-shielding wall 36, but is not optically shielded from the light receiver 43. Therefore, the irradiation light from the light source part 35 can be reflected inside the housing of the distance measuring module 23 and enters the light receiver 43. The light source part 35 is a light source having a characteristic different from that of the light source part 31, and is, for example, a light-emitting diode (LED). In this case, the light emitted from the light source part 35 is not laser light but normal light. The wavelength of the emitted light from the light source part 35 is arbitrarily selected according to the application of the distance measuring module 23, but is preferably a wavelength at which a member that reflects the irradiation light from the light source part 35 sufficiently reflects the irradiation light.

The distance measuring sensor 34 is a sensor that measures the distance to the object 12. The distance measuring sensor 34 includes a timing control circuit 41, the light source control circuit 42, the light receiver 43, and a sensor control circuit 44.

The timing control circuit 41 is a circuit that controls the distance measurement timing of the distance measuring module 23 under the control of the controller 22. For example, the timing control circuit 41 supplies an emission control signal for controlling the timing of emitting the emitted light from the light source part 31 to the light source control circuit 42. Further, for example, the timing control circuit 41 supplies the sensor control circuit 44 with a clock signal, and a start signal for starting and a stop signal for stopping the measurement of the distance measuring time.

The light source control circuit 42 controls the timing of emitting the emitted light (hereinafter also referred to as first light) from the light source part 31, the light amount of the emitted light, and the like. Further, the light source control circuit 42 controls the timing of emitting the emitted light (hereinafter also referred to as second light) from the light source part 35, the light amount of the emitted light, and the like.

Although not illustrated in FIG. 1, the light receiver 43 includes a first photosensor that receives reflected light (hereinafter also referred to as first reflected light) from the object 12 and a second photosensor (hereinafter also referred to as second reflected light) that receives reflected light reflected inside the housing of the distance measuring module 23, as described later. The first photosensor and the second photosensor include a plurality of pixels arranged two-dimensionally. The light receiver 43 outputs a pixel signal corresponding to the amount of received first reflected light to the sensor control circuit 44, and outputs a pixel signal corresponding to the amount of received second reflected light to the sensor control circuit 44.

The sensor control circuit 44 detects a distance measuring time from when the light source part 31 emits the first light to when the first photosensor of the light receiver receives the first reflected light on the basis of the pixel signal from the light receiver 43. This distance measurement time is subjected to arithmetic processing in the sensor control circuit 44 or the controller 22, and the distance from the electronic device 11 to the object 12 is calculated. Note that the sensor control circuit 44 is only required to obtain the emission time of the first light from the timing control circuit 41. Further, the sensor control circuit 44 sets a bias voltage to be applied to the first photosensor on the basis of the pixel signal from the second photosensor of the light receiver 43, and applies the bias voltage to the first photosensor at the time of detection of the first reflected light.

The display part 24 includes, for example, a display device such as a display. The display part 24 displays, for example, a measurement result of the distance to each portion of the object 12, an operation screen for performing distance measurement, or a value of a bias voltage that is applied to the first photosensor.

The storage part 25 stores data necessary for the processing of the controller 22, a program, data obtained by the processing of the controller 22 and the sensor control circuit 44, and the like. For example, the storage part 25 stores three-dimensional distance data indicating a measurement result of the distance to each portion of the object 12. In addition, the storage part 25 stores the transition of the bias voltage applied to the first photosensor.

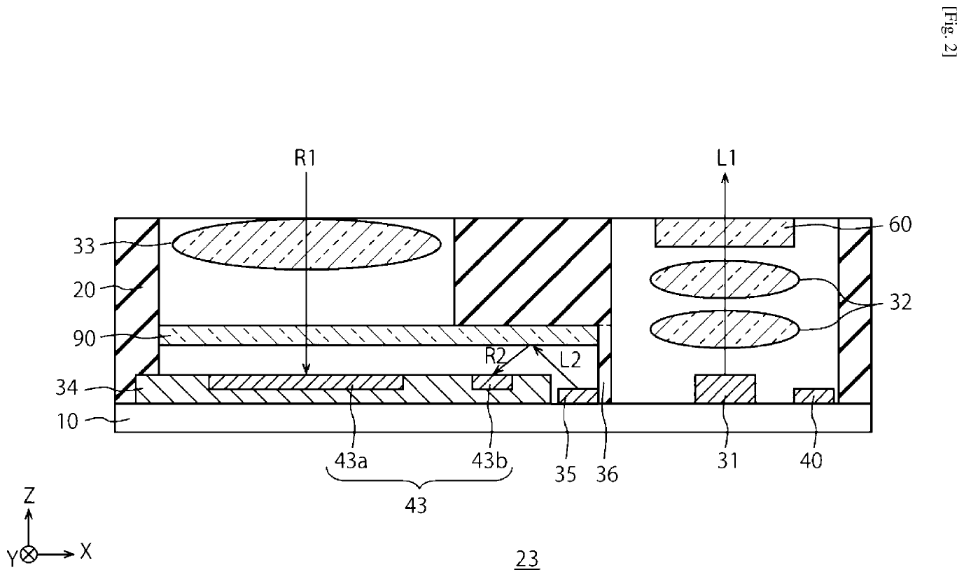

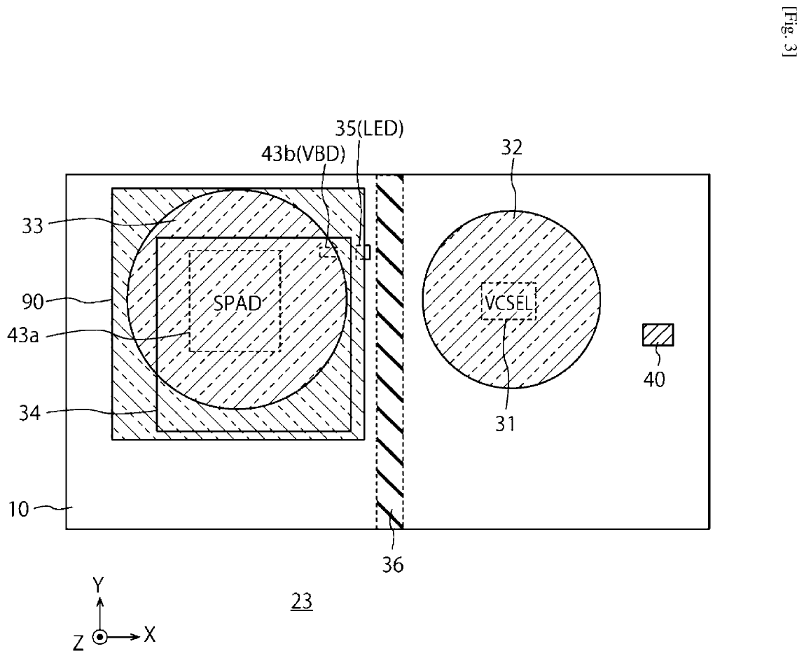

FIG. 2 is a cross-sectional view illustrating a configuration example of the distance measuring module 23. FIG. 3 is a plan view illustrating a configuration example of the distance measuring module 23. As illustrated in FIG. 2, the distance measuring module 23 includes a support substrate 10, a housing 20, the light source parts 31, 35, the lenses 32, 33, the distance measuring sensor 34, the light-shielding wall 36, a light source driver 40, a diffractive optical element (DOE) 60, and an optical filter 90.

The support substrate 10 is a substrate on which each component of the distance measuring module 23 is mounted, and includes a rigid and electrically insulating material. For example, resin, insulating metal, or the like is used for the support substrate 10.

The housing 20 houses each component of the distance measuring module 23 between the housing and the support substrate 10 and fixes each component to the support substrate 10. In addition, the housing 20 is configured to be able to emit the first light from the light source part 31 to the outside and to enable entry of first reflected light R1. For the housing 20, for example, an insulating material such as resin or insulating metal is used.

As described above, the light source part 31 emits a pulsed first light L1. The first light L1 is transmitted through the light source lens 32 and the DOE 60, is applied to the object 12, is transmitted through the imaging lens 33 as the first reflected light R1 reflected by the object 12, and enters a first photosensor 43a of the light receiver 43. The light source part 31 has, for example, a VCSEL structure, and the first light and the first reflected light are laser light.

As described above, the light source part 35 emits a light pulsed second light L2. The second light L2 is applied to the optical filter 90 inside the housing 20, and the second reflected light R2 reflected by the optical filter 90 enters a second photosensor 43b of the light receiver 43. The light source part 35 is, for example, an LED, and the second light and the second reflected light are normal light that is not laser light. Note that the light source part 35 may not be provided immediately below the lens 33, and the housing may be provided immediately above the light source part 35.

The lens 32 transmits and shapes the first light L1. The lens 33 transmits the first reflected light R1 and condenses the first reflected light R1 on the first photosensor 43a.

The DOE 60 diffracts the first light L1 and emits the first light L1 to the outside.

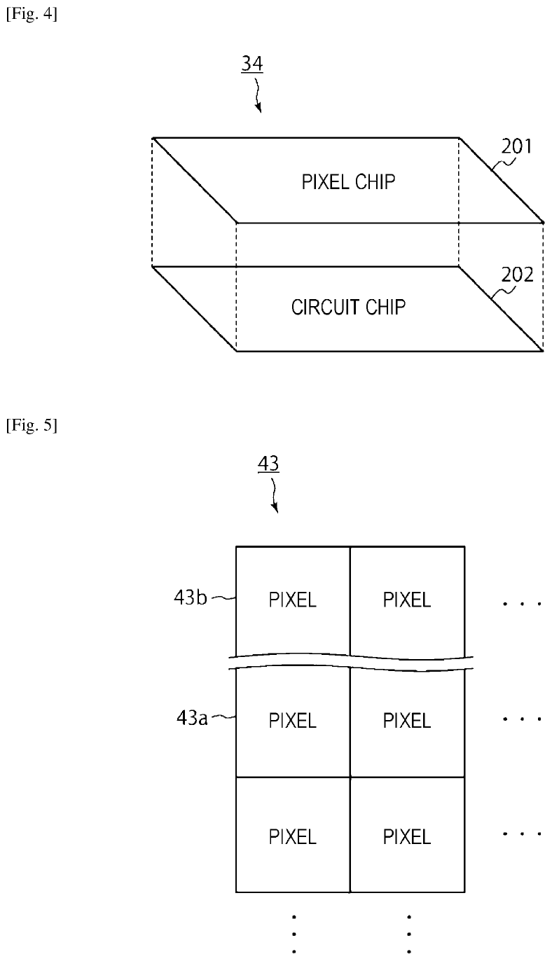

The distance measuring sensor 34 is configured as one semiconductor chip and includes the light receiver 43 provided on a semiconductor substrate. The light receiver 43 includes the first photosensor 43a and the second photosensor 43b in one semiconductor chip. In addition, the timing control circuit 41, the light source control circuit 42, and the sensor control circuit 44 illustrated in FIG. 1 may also be provided in the same semiconductor chip. Note that, as illustrated in FIG. 4, the distance measuring sensor 34 may be a stacked chip of a pixel chip 201 and a circuit chip 202. FIG. 4 is a schematic diagram illustrating an example of the chip configuration of the distance measuring sensor 34. In this case, the light receiver 43 is provided in the pixel chip 201. Circuits such as the timing control circuit 41, the light source control circuit 42, and the sensor control circuit 44 are provided on the circuit chip 202. The pixel chip 201 and the circuit chip 202 may be electrically connected through a via such as through-silicon via (TSV), or may be electrically connected by Cu—Cu bonding or bump bonding.

FIG. 2 is referred to again. The light receiver 43 includes the first photosensor 43a and the second photosensor 43b. The first photosensor 43a detects the first reflected light R1, which is the first light L1 reflected by the object 12 located outside the housing 20. The first photosensor 43a includes a plurality of pixels arranged two-dimensionally. As the first photosensor 43a, for example, a photosensor such as a SPAD is used. The first photosensor 43a outputs a pixel signal corresponding to the amount of received first reflected light R1 to the sensor control circuit 44. At this time, the pixel signal from the first photosensor 43a undergoes analog-to-digital (AD) conversion and is output as a digital signal of the pixel signal.

The second photosensor 43b detects the second reflected light R2, which is the second light L2 reflected by the optical filter 90 located inside the housing 20. The second photosensor 43b includes a plurality of pixels arrayed two-dimensionally. The second photosensor 43b is provided at a position separated from the first photosensor 43a, but a photosensor such as a SPAD is also used as the second photosensor 43b, for example. The photodiode of the second photosensor 43b preferably has the same configuration as the configuration of the photodiode of the first photosensor 43a. This makes the second photosensor 43b usable to set a reverse bias voltage to be applied to the first photosensor 43a when the first photosensor 43a detects the first reflected light R1. In addition, the first photosensor 43a and the second photosensor 43b can be manufactured simultaneously. The second photosensor 43b outputs the cathode voltage (quench voltage) of the second photosensor 43b reacted by the second reflected light to the sensor control circuit 44 as a pixel signal. At this time, the pixel signal from the second photosensor 43b is output as an analog signal indicating the voltage value. The reverse bias voltage to be applied to the first photosensor 43a is set on the basis of this analog signal.

As described above, the light source part 35 and the second photosensor 43b are a light source and a photosensor for bias adjustment to set the reverse bias voltage to be applied to the first photosensor 43a. The light source part 31 and the first photosensor 43a are a light source and a photosensor for distance measurement to measure the distance from distance measuring module 23 to object 12.

The light-shielding wall 36 is provided between the light source part 31 and the light source part 35 and shields the first light L1 and the second light L2. Therefore, the first light L1 does not enter the distance measuring sensor 34 side, and conversely, the second light L2 does not enter the light source part 31 side. The light-shielding wall 36 is provided between the housing 20 and the support substrate 10. The lower end of the light-shielding wall 36 is connected to the surface of the support substrate 10, and the upper end thereof is connected to the housing 20. For example, an opaque material such as resin or metal is used for the light-shielding wall 36. The light-shielding wall 36 may be formed integrally with the housing 20 using the same material.

The light-shielding wall 36 is not provided on the semiconductor chip of the light receiver 43. In a case where the light-shielding wall 36 is provided on the semiconductor chip, optical characteristics or electrical characteristics of the semiconductor chip change. In addition, it may be difficult to design the light-shielding wall 36 to keep the optical characteristics or electrical characteristics of the semiconductor chip. In contrast, in the present embodiment, the light-shielding wall 36 is not provided on the semiconductor chip of the light receiver 43. This facilitates the assembly of the distance measuring module 23 without changing the optical characteristics or the electrical characteristics of the light receiver 43.

As illustrated in FIG. 3, the light-shielding wall 36 is provided to optically separate the light-emitting side of the first light L1 with the light source part 31, the lens 32, and the like from the light-receiving side of the first reflected light R1 with the light receiver 43, the lens 33, and the like. The light-shielding wall 36 is provided to divide the center of the distance measuring module 23 by two as viewed from the emission direction of the first light L1.

The light source driver 40 drives the light source parts 31, 35 to emit light.

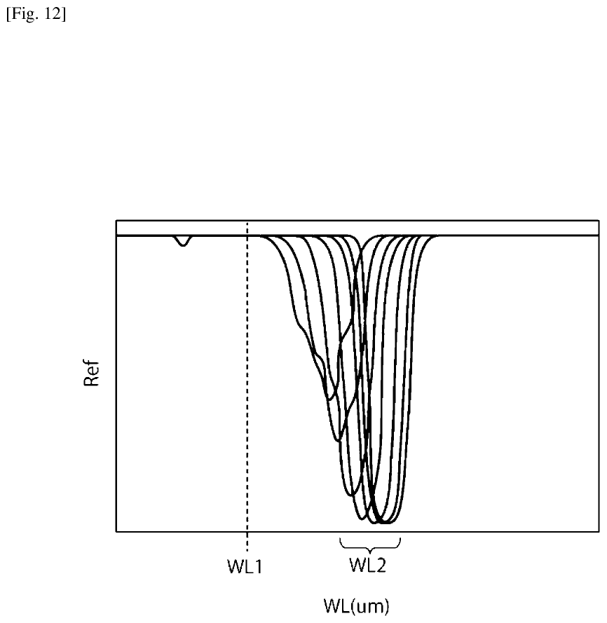

The optical filter 90 is, for example, a bandpass filter, and allows light in a predetermined frequency band of the first reflected light R1 to pass through the first photosensor 43a. On the other hand, the optical filter 90 reflects the second light L2 to the second photosensor 43b. As illustrated in FIG. 12, the transmittance of the first light L1 to the optical filter 90 is higher than the transmittance of the second light L2 to the optical filter 90. Further, the reflectance of the first light L1 from the optical filter 90 is lower than the reflectance of the second light L2 from the optical filter 90. In this way, the material of the optical filter 90, the wavelength of the first light L1, the wavelength of the second light L2, and the relative position between the light source part 35 and the second photosensor 43b are set so that the optical filter 90 transmits the first light L1 and reflects the second light L2. For example, the angle of incidence of the second light L2 on the optical filter 90 is determined by the relative position between the light source part 35 and the second photosensor 43b. Therefore, the positional relationship between the light source part 35 and the second photosensor 43b is set so that the angle of incidence of the second light L2 on the optical filter 90 is close to the critical angle or is greater than or equal to the critical angle.

FIG. 5 is a plan view illustrating a configuration example of the light receiver 43. The first and second photosensors 43a, 43b include a plurality of pixels each including a photodiode and a pixel circuit. The plurality of pixels is two-dimensionally arranged, for example, in a matrix in the first and second photosensors 43a, 43b. The plurality of pixels constituting the first and second photosensors 43a, 43b has, for example, SPADs with the same configuration. The pixel circuits of the first and second photosensors 43a, 43b have configurations different from each other.

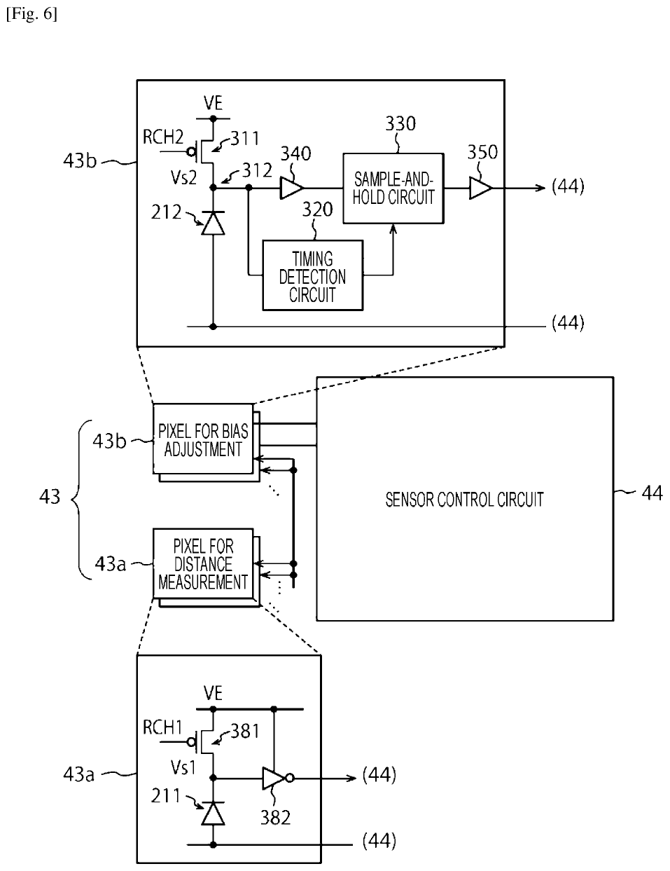

FIG. 6 is a block diagram illustrating a configuration example of the light receiver 43 and the sensor control circuit 44. The pixels of the first photosensor 43a are pixels for distance measurement. Each pixel of the first photosensor 43a includes a SPAD 211, a p-type metal oxide semiconductor (MOS) transistor 381, and an inverter 382. The transistor 381 and the inverter 382 constitute the pixel circuit (first pixel circuit) of each pixel of the first photosensor 43a.

The anode of the SPAD 211 is connected to the low-level voltage source (reference voltage source). The cathode of the SPAD 211 is connected to a drain of the transistor 381. The source of the transistor 381 is connected to a power supply VE. The gate of the transistor 381 receives a control signal RCH1 from the sensor control circuit 44. A sense node Vs1 between the transistor 381 and the SPAD 211 is connected to the input of the inverter 382. The output of the inverter 382 is connected to the sensor control circuit 44.

The control signal RCH1 falls to the low-level voltage (low active) at the time of recharging the sense node Vs1. When the control signal RCH1 falls to the low-level voltage, the transistor 381 enters a conductive state, and the sense node Vs1 is charged to the high-level voltage by the power supply VE. At this time, the inverter 382 outputs the logic low to the sensor control circuit 44. When the sense node Vs1 is charged, the control signal RCH1 rises to a high-level voltage, the transistor 381 enters a non-conductive state, and the sense node Vs1 remains in the state of the high-level voltage.

When the sense node Vs1 is charged, a reverse bias voltage is applied to the SPAD 211 between the sense node Vs1 and the low-level voltage source. When the photon of the first reflected light R1 enters the SPAD 211 in the reverse bias state, the SPAD 211 is avalanche multiplied, and the charges of the sense node Vs1 instantaneously flow to the low-level voltage source side. As a result, the sense node Vs1 decreases from the high-level voltage to the low-level voltage, and the output of the inverter 382 is inverted from the logic low to the logic high. Then, the SPAD 211 returns to the state before avalanche breakdown (quenching). Thereafter, the control signal RCH1 falls to the low-level voltage again, and the sense node Vs1 is recharged to the high-level voltage by the power supply VE. At this time, the output of the inverter 382 returns to the logic low.

As described above, the SPAD 211 of the first photosensor 43a detects entry of the photon, and the pixel circuit can output a pulse signal to the sensor control circuit 44 every time the photon enters. That is, the pixel circuit including the transistor 381 and the inverter 382 performs analog-to-digital (AD) conversion on the pixel signal of the pixel (the voltage value of the sense node Vs1) in the first photosensor 43a and outputs the pulse signal (digital signal) of the pixel signal.

The sensor control circuit 44 measures the distance from the distance measuring module 23 to the object 12 by measuring the period from the light emission of the light source part 31 to the pulse signal from the first photosensor 43a.

The pixels of the second photosensor 43b are pixels for adjusting the reverse bias voltages to be applied to the SPADs 211 of the respective pixels of the first photosensor 43a. Each pixel of the second photosensor 43b includes a SPAD 212, a p-type MOS transistor 311, a timing detection circuit 320, a sample-and-hold circuit 330, and buffers 340, 350. The transistor 311, the timing detection circuit 320, the sample-and-hold circuit 330, and the buffers 340, 350 constitute a pixel circuit (second pixel circuit) of each pixel of the second photosensor 43b.

The anode of the SPAD 212 is connected to the low-level voltage source (reference voltage source). The cathode of the SPAD 212 is connected to the drain of the transistor 311. The source of the transistor 311 is connected to the power supply VE. The gate of the transistor 311 receives a control signal RCH2 from the sensor control circuit 44. A sense node Vs2 between the transistor 311 and the SPAD 212 is connected to the input of the buffer 340 and the timing detection circuit 320. The outputs of the timing detection circuit 320 and the buffer 340 are connected to the sample-and-hold circuit 330. The output of the sample-and-hold circuit 330 is connected to the input of the buffer 350. The output of the buffer 350 is connected to the sensor control circuit 44.

The control signal RCH2 falls to the low-level voltage (low active) at the time of recharging the sense node Vs2. When the control signal RCH2 falls to the low-level voltage, the transistor 311 enters the conductive state, and the sense node Vs2 is charged to the high-level voltage by the power supply VE. At this time, the buffer 340 outputs the voltage (analog value) of the sense node Vs2 to the sample-and-hold circuit 330.

The sample-and-hold circuit 330 is controlled by the timing detection circuit 320, samples the voltage of the sense node Vs2 as the second pixel signal at a predetermined timing, and holds the voltage.

The timing detection circuit 320 outputs a pulse signal to the sample-and-hold circuit 330 at a predetermined timing on the basis of the voltage of the sense node Vs2. The sample-and-hold circuit 330 receives the pulse signal from the timing detection circuit 320, samples the voltage of the sense node Vs2, and holds the voltage.

The buffer 350 outputs the voltage of the sense node Vs2 held by the sample-and-hold circuit 330 to the sensor control circuit 44.

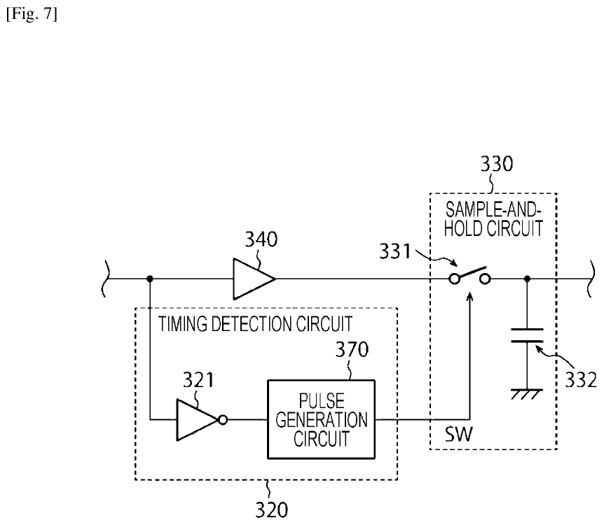

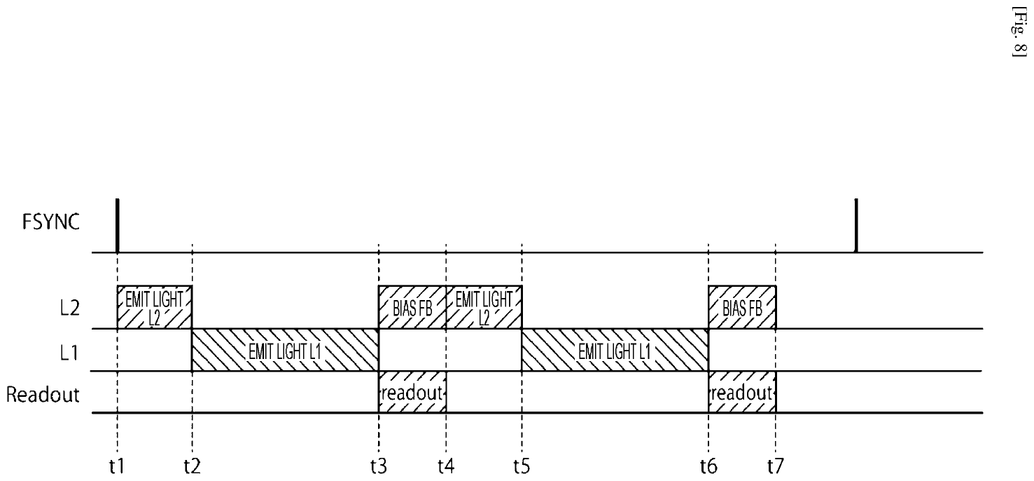

FIG. 7 is a block diagram illustrating a configuration example of the timing detection circuit 320 and the sample-and-hold circuit 330.

The sample-and-hold circuit 330 is only required to include a switch 331, a capacitive element 332, and the like to execute the above functions. The switch 331 is connected between the buffer 340 and the buffer 350 and is brought into the conductive state or the non-conductive state by a pulse signal from the timing detection circuit 320. The capacitive element 332 is connected between a node between the switch 331 and the buffer 350 and a reference voltage (e.g., ground) and can store charges according to the voltage of the sense node Vs2.

The timing detection circuit 320 is only required to include the inverter circuit 321, the pulse generation circuit 370, and the like to execute such a function. The inverter circuit 321 inverts the voltage level of the sense node Vs2 and outputs the inverted voltage level to the pulse generation circuit 370. The pulse generation circuit 370 delays the pulse signal by a predetermined time according to the output voltage level from the inverter circuit 321 and outputs the delayed pulse signal to the switch 331.

When the sense node Vs2 is charged, a reverse bias voltage is applied to the SPAD 212 between the sense node Vs2 and the low-level voltage source. When the photon of the second reflected light R2 enters the SPAD 212 in the reverse bias state, the SPAD 212 is avalanche multiplied, and the charges of the sense node Vs2 instantaneously flow to the low-level voltage source side. As a result, the sense node Vs2 outputs a pulse signal after a predetermined delay time has elapsed from the voltage change of the sense node Vs2. The sample-and-hold circuit 330 receives a pulse signal from the timing detection circuit 320 and brings the switch 331 into the conductive state only during a period of the pulse signal. Thereby, the sample-and-hold circuit 330 samples and holds the voltage (analog value) of the sense node Vs2 in the capacitive element 332. The voltage of the sense node Vs2 is held in the capacitive element 332 and output from the sample-and-hold circuit 330 to the sensor control circuit 44.

As described above, the SPAD 211 of the second photosensor 43b can detect the entry of photons and output the voltage of the sense node Vs2 to the sensor control circuit 44. That is, the pixel circuit of each pixel of the second photosensor 43b outputs the pixel signal of the pixel (the voltage value of the sense node Vs2) in the second photosensor 43b as an analog signal.

The sensor control circuit 44 sets the reverse bias voltage to be applied to the SPAD 211 of the first photosensor 43a on the basis of the pixel signal of the pixel of the second photosensor 43b. This enables the sensor control circuit 44 to apply, to the SPAD 211, a reverse bias voltage adapted to variations in the electrical characteristics of the first photosensor 43a due to changes in photosensitivity such as temperature. As a result, the distance measurement accuracy of the distance measuring module 23 can be optimized to improve the characteristics of the first photosensor 43a.

The distance measuring module 23 according to the present embodiment includes light source parts 31, 35 having different characteristics. The light source part 31 is used as a light source for distance measurement, and the light source part 35 is used to adjust the reverse bias voltage to be applied to the SPAD 211 of the first photosensor 43a. As illustrated in FIG. 2, the light source part 35 is optically separated from the light source part 31 by a light-shielding wall 36. Hence the first light L1 does not enter the first and second photosensors 43a, 43b side inside the distance measuring module 23. Conversely, the second light L2 does not enter the light-emitting side of the first photosensor 43a inside the distance measuring module 23. Therefore, while the light source part 31 for distance measurement includes a laser light-emitting element (e.g., VCSEL), the bias voltage adjustment light source part 35 can include a light-emitting element (e.g., an LED) that emits normal light. The LED is inexpensive compared to the VCSEL, and the cost increase is very small. Further, at the time of adjusting the bias voltage of the first photosensor 43a, there is no need to commonly use the light source part 31 for distance measurement. Thus, there is no need to cause a part of the first light L1 from the light source part 31 to reflect inside the distance measuring module 23 and enter the second photosensor 43b. Therefore, the distance measuring module 23 according to the present embodiment has a limited manufacturing cost and a simple configuration. Furthermore, even when the light source parts 31, 35 emit light simultaneously, the light-shielding wall 36 can prevent the contamination of the first light L1 and the second light L2.

Note that the light source part 31 may be a laser light-emitting element other than the VCSEL. The light source part 35 may be a light-emitting element other than the LED.

Next, the operation of the distance measuring module 23 according to the present embodiment will be described.

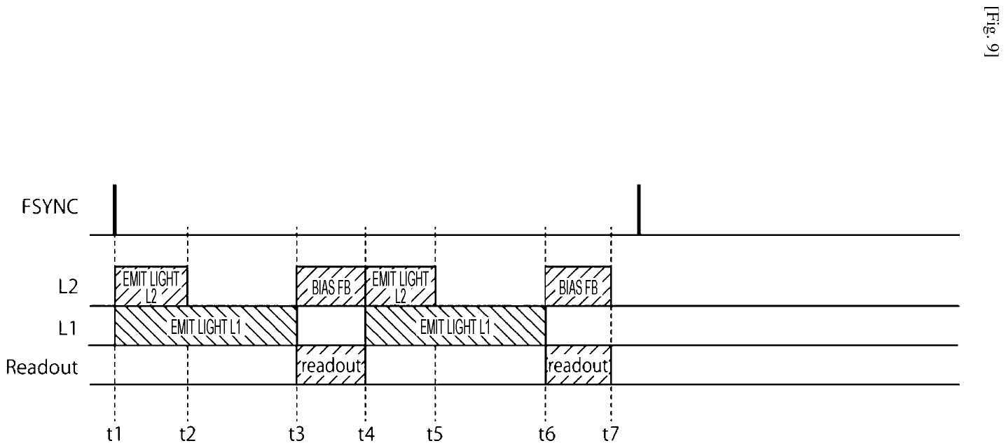

FIG. 8 is a timing diagram illustrating an example of the operation of the distance measuring module 23 according to the first embodiment. The horizontal axis represents time. A signal FSYNC is a frame synchronization signal and is a signal indicating the start of distance measurement.

First, when the signal FSYNC rises at time t1, the distance measuring operation is started, and the light source part 35 emits the second light L2. From t1 to t2, the light source part 35 emits the second light L2, and the second photosensor 43b detects the second reflected light R2. The second light L2 is reflected by the optical filter 90 and enters the second photosensor 43b as the second reflected light R2. Thereby, the sensor control circuit 44 sets the reverse bias voltage to be applied to the SPAD 211 of the first photosensor 43a on the basis of the pixel signal from the second photosensor 43b (the voltage value corresponding to the second reflected light R2).

Next, from t2 to t3, the light source part 31 emits the first light L1. The first light L1 is reflected by the external object 12 and enters the first photosensor 43a as the first reflected light R1.

In the present embodiment, the reverse bias voltage to the first photosensor 43a has not been fed back. Thus, between t2 and t3, the reverse bias voltage to the first photosensor 43a has not been optimized.

Next, from t3 to t4, the sensor control circuit 44 reads the pixel signal from the first photosensor 43a to the controller 22. The controller 22 receives the pixel signal from the first photosensor 43a, and calculates the distance from the distance measuring module 23 to the object 12 on the basis of the time from the emission of the first light L1 by the light source part 31 to the detection of the first reflected light R1 by the first photosensor 43a.

Also, from t3 to t4, the reverse bias voltage to the first photosensor 43a set from t1 to t2 is fed back simultaneously with the reading of the pixel signal. As a result, when the first photosensor 43a next detects the first reflected light R1, the reverse bias voltage to be applied to the SPAD 211 of each pixel of the first photosensor 43a is optimized. That is, when the first photosensor 43a detects the first reflected light R1 from t5 to t6, the reverse bias voltage to be applied to the SPAD 211 of each pixel of the first photosensor 43a can be set to a voltage suitable for the current environment.

Thereafter, from t4 to t7, the same operation as from t1 to t4 (hereinafter also referred to as a distance measurement cycle is repeated. The operation from t1 to t4 and the operation from t4 to t7 may be further repeated.

As described above, in the present embodiment, the light source parts 31, 35 alternately emit the first light L1 and the second light L2. Then, the sensor control circuit 44 sets the reverse bias voltage to be applied to the SPAD 211 of the first photosensor 43a when the next first light L1 is detected on the basis of the pixel signal (analog signal) of the second photosensor 43b obtained by the second light L2. Further, in the present embodiment, the sensor control circuit 44 feeds back the reverse bias voltage in a reading period (e.g., t3 to t4), in which the digital signal of the pixel signal of the first photosensor 43a is output, and sets the reverse bias voltage in the first photosensor 43a. Accordingly, when the first photosensor 43a detects the second reflected light R2 next time, the voltage can be set to a voltage already suitable for the current environment. By overlapping the reading period of the pixel signal of the first photosensor 43a and the feedback period of the reverse bias voltage, one distance measurement cycle (e.g., t1 to t4 or t4 to t7) takes only a short time. That is, the frame rate can be increased.

After the light source part 31 emits the first light L1 (e.g., L1 emitted from t2 to t3) and before the light source part 35 emits the second light L2 (e.g., L2 emitted from t4 to t5), the sensor control circuit 44 sets a reverse bias voltage of the first photosensor 43a to be applied when the next first light L1 (e.g., L1 emitted from t5 to t6) is detected. In this case, the accuracy in the distance measurement using the first light L1 (e.g., L1 emitted from t2 to t3) in the first distance measurement cycle is low. However, thereafter, the accuracy in the distance measurement using the first light L1 (e.g., L1 emitted from t5 to t6) after the second cycle becomes higher. Therefore, the controller 22 is only required to discard the distance calculated in the first distance measurement cycle and adopt the distance calculated in the second and subsequent cycles to obtain the distance to the object 12. As a result, the distance measuring module 23 according to the present embodiment can enhance the distance measurement accuracy.

Further, the drive signals of the light source parts 31, 35 are activated at different timings, and the first light L1 and the second light L2 are emitted at different timings. Accordingly, the first light L1 and the second light L2 are optically separated from each other by the light-shielding wall 36, and is also temporally separated. This makes it possible to further reliably prevent the leakage of the first light L1 and the second light L2.

### Second Embodiment

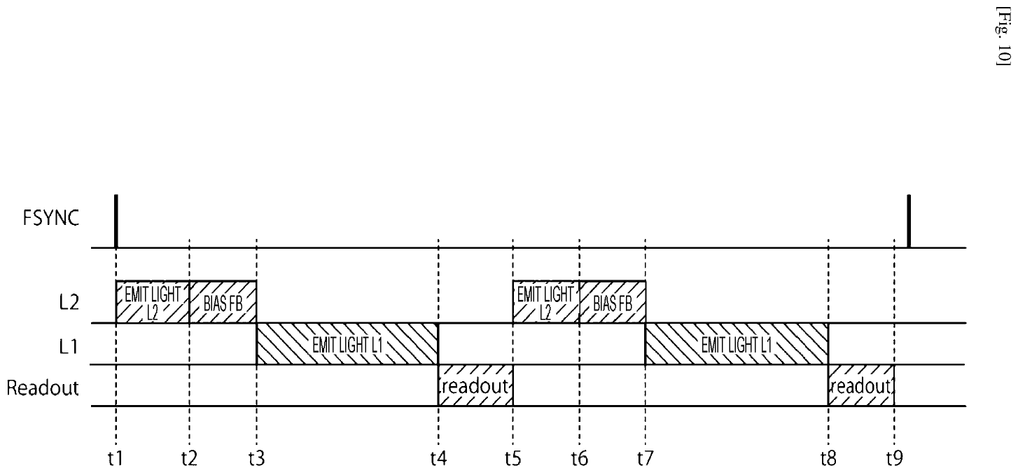

FIG. 9 is a timing diagram illustrating an example of the operation of the distance measuring module 23 according to the second embodiment. In the second embodiment, as indicated by t1 and t3, the light source parts 31, 35 emit the first light L1 and the second light L2 simultaneously. With the light-shielding wall 36 optically shielding between the light source part 31 and the light source part 35, the first light L1 and the second light L2 are not mixed even when emitted simultaneously. Further, as illustrated in FIG. 3, the second photosensor 43b is provided at a position separated from the first photosensor 43a. Therefore, the first reflected light R1 and the second reflected light R2 can enter the first photosensor 43a and the second photosensor 43b simultaneously without being mixed.

The time for emission of the second light L2 by the light source part 35 may be shorter than the time for emission of the first light L1 by the light source part 31. The second light L2 may be emitted for a shorter time because the second light L2 is only used to adjust the reverse bias voltage of the first photosensor 43a. On the other hand, the first light L1 is preferably emitted for a longer time than the second light L2 because the first light L1 is emitted to the outside and used to measure the distance to the object 12,

The emission period of the second light L2 overlaps the emission period of the first light L1, so that the distance measurement cycle from the emission of the light source parts 31, 35 to the emission of the next light source parts 31, 35 can be shortened.

The configuration and other operations of the distance measuring module 23 of the second embodiment may be similar to those of the first embodiment. Therefore, the second embodiment can also obtain the effects similar to those of the first embodiment.

### Third Embodiment

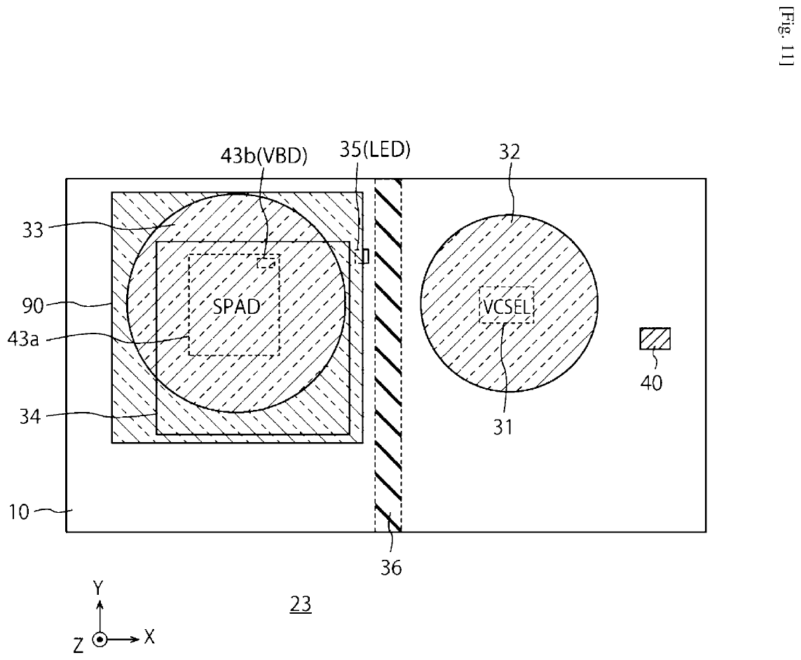

FIG. 10 is a timing diagram illustrating an example of the operation of the distance measuring module 23 according to the third embodiment. In the third embodiment, after the light source part 35 emits the second light L2 and before the light source part 31 emits the first light L1, the sensor control circuit 44 adjusts and sets the reverse bias voltage of the first photosensor 43a. That is, in each distance measurement cycle, the sensor control circuit 44 adjusts the reverse bias voltage of the first photosensor 43a, and then emits the first light L1. Therefore, from the first distance measurement cycle, the reverse bias voltage to be applied to the SPAD 211 of the pixel of the first photosensor 43a has been adjusted to a voltage suitable for the current environment. As a result, the distance measuring module 23 according to the third embodiment can further enhance the distance measuring accuracy.

The configuration and other operations of the distance measuring module 23 of the third embodiment may be similar to those of the first embodiment. Therefore, the third embodiment can also obtain the effects similar to those of the first embodiment.

However, the reading period (e.g., t4 to t5) of the pixel signal of the first photosensor 43a and the feedback period (e.g., t2 to t3) of the reverse bias voltage do not overlap, and the emission period of the second light L2 and the emission period of the first light L1 do not overlap. In one distance measurement cycle, the emission of the second light L2, the feedback and setting of the reverse bias voltage, the emission of the first light L1, and the reading of the pixel signal of the first photosensor 43a are continuously executed in this order. Therefore, the distance measurement cycle of the third embodiment is longer than that of the first or second embodiment.

### Fourth Embodiment

FIG. 11 is a plan view illustrating a configuration example of a distance measuring module 23 according to a fourth embodiment. In the distance measuring module 23 according to the fourth embodiment, the second photosensor 43b is provided in the first photosensor 43a. That is, the first and second photosensors 43a, 43b are provided in one pixel region. In this case, the light-shielding wall 36 optically separates the light source part 31 and the light source part 35, and as illustrated in FIG. 8 or 10, the light emission timings of the first light L1 and the second light L2 are different. Thus, even when the second photosensor 43b is provided in the first photosensor 43a, the first reflected light R1 and the second reflected light R2 can enter the first photosensor 43a the and the second photosensor 43b without being mixed. In this case, the pixels and pixel circuits of the first and second photosensors 43a, 43b can be designed relatively freely without considering leakage light of entering light.

Other configurations and operations of the fourth embodiment may be similar to any of the first to third embodiments. Accordingly, the fourth embodiment can also obtain the effects of any one of the first to third embodiments.

### Fifth Embodiment

FIG. 12 is a graph illustrating an example of characteristics of the optical filter 90. The horizontal axis of this graph indicates the wavelength of the incident light. The vertical axis represents the reflectance of the optical filter 90. The plurality of curves differs in the angle of incidence of light on the optical filter 90.

For various angles of incidence, WL1 can be selected as a wavelength of incident light having high reflectance. Selecting the light having the wavelength WL1 as the second light L2 increases the degree of freedom in the arrangement of the light source part 35 and the second photosensor 43b. In addition, for various angles of incidence, WL2 can be selected as a wavelength of incident light having high transmittance (low reflectance). Selecting the light having the wavelength WL2 as the first light L1 increases the degree of freedom in the arrangement of the light source part 31 and the first photosensor 43a. The transmittance of the first light L1 to the optical filter 90 is higher than the transmittance of the second light L2 to the optical filter 90. Further, the reflectance of the first light L1 from the optical filter 90 is lower than the reflectance of the second light L2 from the optical filter 90. As described above, making the wavelengths of the first light L1 and the second light L2 different from each other facilitates the optical filter 90 to reflect the second light L2 while transmitting the first light L1. For example, the first light L1 may be laser light with a wavelength of about 940 nm, and the second light L2 may be normal light with a wavelength of about 850 nm.

Other configurations and operations of the fifth embodiment may be the same as those of any of the first to fourth embodiments. As a result, the fifth embodiment can obtain the effects similar to those of any of the first to fourth embodiments.

### Sixth Embodiment

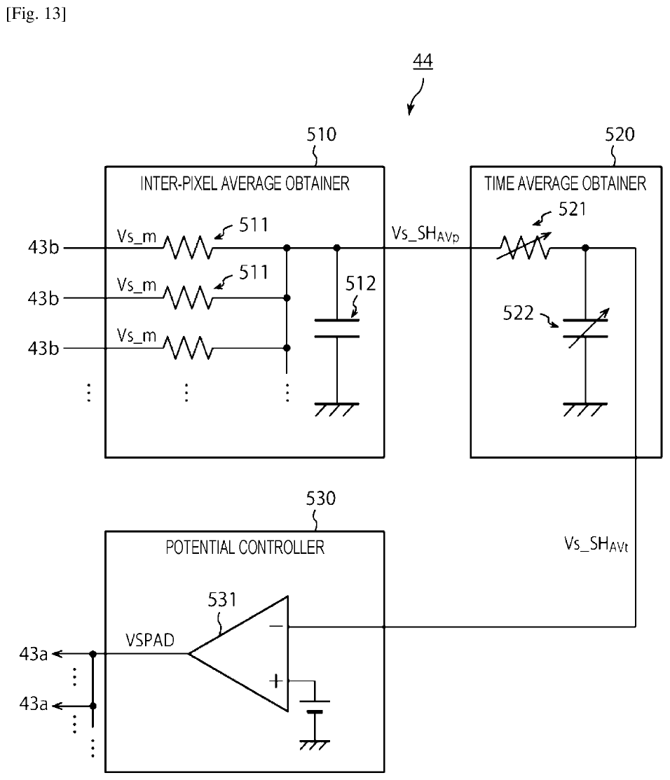

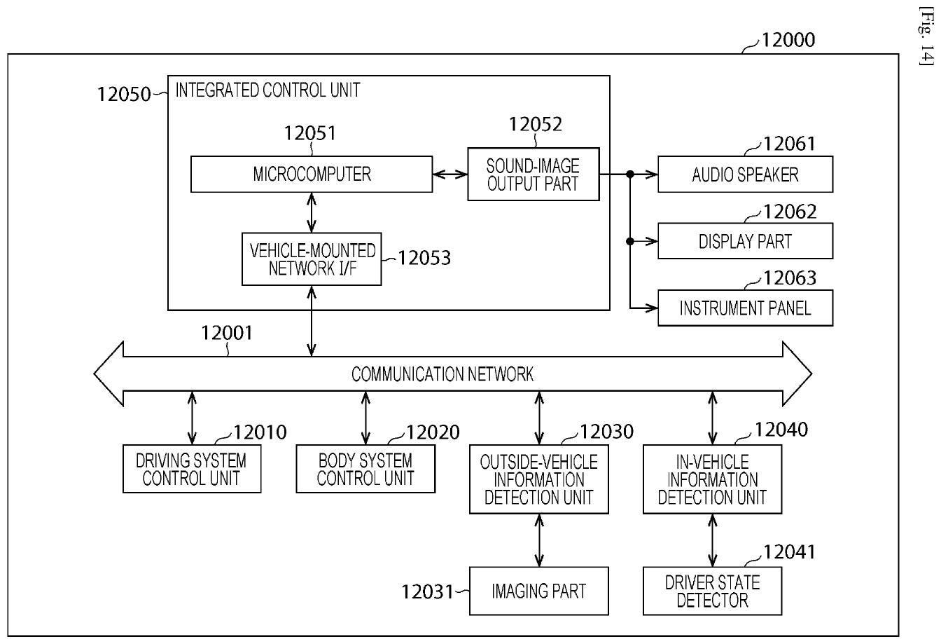

FIG. 13 is a circuit diagram illustrating a configuration example of a part of a sensor control circuit 44 according to the sixth embodiment. In an inter-pixel average obtainer 510, a plurality of resistors 511 and a capacitor 512 are arranged. The resistor 511 is disposed for each pixel of the second photosensor 43b. A variable resistor 521 and a variable capacitor 522 are disposed in the time average obtainer 520. An amplifier 531 is disposed in a potential controller 530.

In the inter-pixel average obtainer 510, one end of the resistor 511 is connected to each pixel of the second photosensor 43b, and the other end thereof is connected to one end of the capacitor 512 and the time average obtainer 520. That is, the plurality of resistors 511 is connected in parallel between the plurality of pixels of the second photosensor 43b and the capacitor 512. The other end of the capacitor 512 is connected to the ground potential. With these resistors 511, an average potential of potentials Vs_m held by the sample-and-hold circuits 330 of the plurality of pixels of the second photosensor 43b is generated as an inter-pixel average Vs_SHAVp and held in the capacitor 512. Obtaining the inter-pixel average can inhibit an adverse effect due to the variation in the holding potential Vs_m among the pixels.

Further, in the time average obtainer 520, one end of the variable resistor 521 is connected to the inter-pixel average obtainer 510, and the other end thereof is connected to one end of the variable capacitor 522 and the potential controller 530. The other end of the variable capacitor 522 is connected to the ground potential. The circuit including the variable resistor 521 and the variable capacitor 522 functions as an analog low-pass filter that generates the time average Vs_SHAVt of the inter-pixel average Vs_SHAVp.

In the potential controller 530, the time average Vs_SHAVt is input to the inverting input terminal (−) of the amplifier 531, and the predetermined power supply potential VREF is input to the non-inverting input terminal (+) of the amplifier 531. The amplifier 531 generates the comparison result as a reverse bias voltage VSPAD according to the following equation, and supplies the comparison result to the anode of the SPAD 211 of each pixel of the first photosensor 43a. The reverse bias voltage VSPAD is expressed by Expression 1.

$$VSPAD = Av ( VREF - Vs\_SHAVt ) \qquad ( Expression 1 )$$

Note that in the above expression, Av is the gain of the amplifier 531.

Other configurations and operations of the sixth embodiment may be the same as those of any of the first to fifth embodiments. As a result, the sixth embodiment can obtain the effects similar to those of any of the first to fifth embodiments.

### (Application Example to Mobile Body)

The technology according to the present disclosure (present technology) can be applied to various products. For example, the technology according to an embodiment of the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

FIG. 14 is a block diagram illustrating a schematic configuration example of a vehicle control system that is an example of a mobile object control system to which the technology according to the present disclosure can be applied.

A vehicle control system 12000 includes a plurality of electronic control units connected to each other via a communication network 12001. In the example illustrated in FIG. 14, the vehicle control system 12000 includes a driving system control unit 12010, a body system control unit 12020, an outside-vehicle information detection unit 12030, an in-vehicle information detection unit 12040, and an integrated control unit 12050. In addition, a microcomputer 12051, a sound-image output part 12052, and a vehicle-mounted network interface (I/F) 12053 are illustrated as a functional configuration of the integrated control unit 12050.

The driving system control unit 12010 controls the operation of devices related to the driving system of the vehicle according to various kinds of programs. For example, the driving system control unit 12010 functions as a control device for a driving force generation device for generating the driving force of the vehicle, such as an internal combustion engine or a driving motor, a driving force transmitting mechanism for transmitting the driving force to wheels, a steering mechanism for adjusting the steering angle of the vehicle, and a braking device for generating the braking force of the vehicle.

The body system control unit 12020 controls the operation of various kinds of devices provided to a vehicle body according to various kinds of programs. For example, the body system control unit 12020 functions as a control device for a keyless entry system, a smart key system, a power window device, or various kinds of lamps such as a headlamp, a backup lamp, a brake lamp, a turn signal, or a fog lamp. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detection unit 12030 detects information about the outside of the vehicle including the vehicle control system 12000. For example, an imaging part 12031 is connected to the outside-vehicle information detection unit 12030. The outside-vehicle information detection unit 12030 causes the imaging part 12031 to capture an image of the outside of the vehicle, and receives the captured image. On the basis of the received image, the outside-vehicle information detection unit 12030 may perform processing of detecting an object such as a human, a vehicle, an obstacle, a sign, or a character on a road surface, or processing of detecting a distance thereto.

The imaging part 12031 is a photosensor that receives light and outputs an electric signal corresponding to the light reception amount of the light. The imaging part 12031 can output the electric signal as an image, or can output the electric signal as information about a measured distance. In addition, the light received by the imaging part 12031 may be visible light or may be invisible light such as infrared rays.

The in-vehicle information detection unit 12040 detects information about the inside of the vehicle. For example, a driver state detector 12041 for detecting the state of a driver is connected to the in-vehicle information detection unit 12040. The driver state detector 12041, for example, includes a camera that images the driver. On the basis of detection information input from the driver state detector 12041, the in-vehicle information detection unit 12040 may calculate the degree of fatigue of the driver or the degree of concentration of the driver or may determine whether the driver is awake.

The microcomputer 12051 can calculate a control target value for the driving force generation device, the steering mechanism, or the braking device on the basis of the information about the inside or outside of the vehicle, which is obtained by the outside-vehicle information detection unit 12030 or the in-vehicle information detection unit 12040, and can output a control command to the driving system control unit 12010. For example, the microcomputer 12051 can perform cooperative control intended to implement functions of an advanced driver assistance system (ADAS), the functions including collision avoidance or shock mitigation for the vehicle, following traveling based on a following distance, constant vehicle speed traveling, a warning of collision of the vehicle, a warning of deviation of the vehicle from a lane, and the like.

Further, the microcomputer 12051 can perform cooperative control intended for automated driving, in which the vehicle travels in an automated manner without depending on the operation of the driver, or the like, by controlling the driving force generation device, the steering mechanism, the braking device, or the like on the basis of information about the surroundings of the vehicle obtained by the outside-vehicle information detection unit 12030 or the in-vehicle information detection unit 12040.

In addition, the microcomputer 12051 can output a control command to the body system control unit 12020 on the basis of the information about the outside of the vehicle obtained by the outside-vehicle information detection unit 12030. For example, the microcomputer 12051 can perform cooperative control intended to prevent glare by controlling the headlamp so as to change from a high beam to a low beam, for example, according to the position of a preceding vehicle or an oncoming vehicle detected by the outside-vehicle information detection unit 12030.

The sound-image output part 12052 transmits an output signal of at least one of a sound or an image to an output device capable of visually or auditorily notifying an occupant of the vehicle or the outside of the vehicle of information. In the example of FIG. 14, an audio speaker 12061, a display part 12062, and an instrument panel 12063 are illustrated as output devices. The display part 12062 may, for example, include at least one of an on-board display or a head-up display.

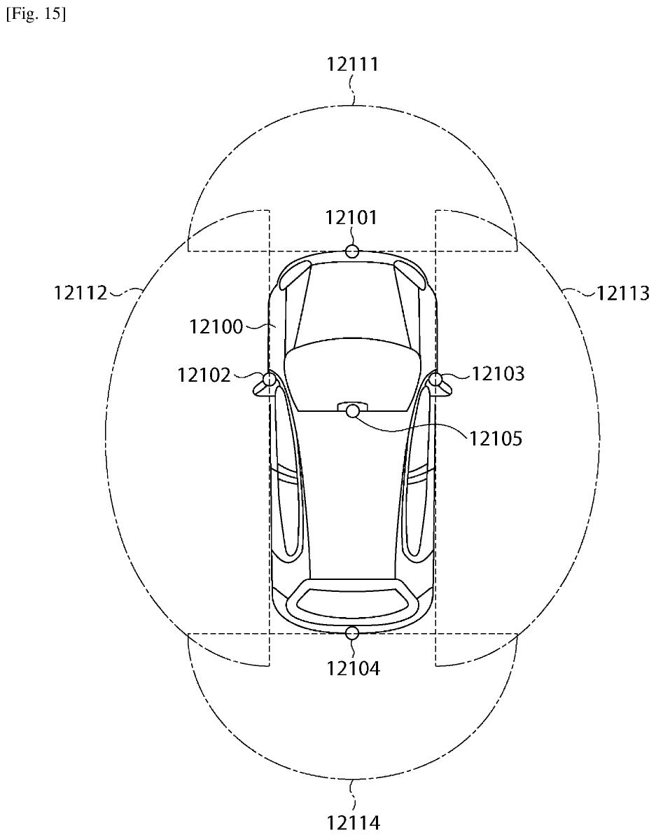

FIG. 15 is a diagram illustrating an example of an installation position of the imaging part 12031.

In FIG. 15, the imaging part 12031 includes imaging parts 12101, 12102, 12103, 12104, 12105.

The imaging parts 12101, 12102, 12103, 12104, 12105 are, for example, disposed at positions on a front nose, side-view mirrors, a rear bumper, and a back door of a vehicle 12100, an upper portion of a windshield within the interior of the vehicle, or some other positions. The imaging part 12101 provided on the front nose and the imaging part 12105 provided in the upper portion of the windshield within the interior of the vehicle mainly obtain the image of the front of the vehicle 12100. The imaging parts 12102, 12103 provided on the side-view mirrors mainly obtain the image of the sides of the vehicle 12100. The imaging part 12104 provided on the rear bumper or the back door mainly obtains the image of the rear of the vehicle 12100. The imaging part 12105 provided in the upper portion of the windshield within the interior of the vehicle is mainly used to detect a preceding vehicle, a pedestrian, an obstacle, a signal, a traffic sign, a lane, or the like.

Note that FIG. 15 illustrates an example of imaging ranges of the imaging parts 12101 to 12104. An imaging range 12111 indicates the imaging range of the imaging part 12101 on the front nose, imaging ranges 12112, 12113 indicate the imaging ranges of the imaging parts 12102 and 12103 on the side-view mirrors, respectively, and an imaging range 12114 indicates the imaging range of the imaging part 12104 on the rear bumper or the back door. The bird's-eye image of the vehicle 12100 as viewed from above is obtained by superimposing pieces of image data captured by the imaging parts 12101 to 12104, for example.

At least one of the imaging parts 12101 to 12104 may have a function of obtaining distance information. For example, at least one of the imaging parts 12101 to 12104 may be a stereo camera including a plurality of imaging elements, or may be an imaging element having pixels for phase difference detection.

For example, the microcomputer 12051 can obtain a distance to each three-dimensional object within the imaging ranges 12111 to 12114 and a temporal change in the distance (a relative speed to the vehicle 12100) on the basis of the distance information obtained from the imaging parts 12101 to 12104, and thereby extract, as the preceding vehicle, especially the nearest three-dimensional object that is on the traveling path of the vehicle 12100 and travels at a predetermined speed (e.g., 0 km/hour or higher) in a direction substantially the same as that of the vehicle 12100. Moreover, the microcomputer 12051 can set an inter-vehicular distance to be ensured in advance from the preceding vehicle and perform automatic brake control (including following stop control), automatic acceleration control (including following start control), or the like. It is thus possible to perform cooperative control intended for automated driving, in which the vehicle travels automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging parts 12101 to 12104, extract the classified three-dimensional object data, and use the extracted three-dimensional object data for automatic avoidance of an obstacle. For example, the microcomputer 12051 identifies obstacles around the vehicle 12100 as obstacles visible to the driver of the vehicle 12100 and obstacles difficult for the driver to view. Then, the microcomputer 12051 determines a collision risk indicating a risk of collision with each obstacle. In a situation in which the collision risk is higher than or equal to a set value and there is thus a possibility of collision, the microcomputer 12051 can outputs a warning to the driver via the audio speaker 12061 or the display part 12062 and perform forced deceleration or avoidance steering via the driving system control unit 12010 to perform driving assistance to avoid collision.

At least one of the imaging parts 12101 to 12104 may be an infrared camera that detects infrared rays. For example, the microcomputer 12051 can recognize a pedestrian by determining whether or not there is a pedestrian in the captured images of the imaging parts 12101 to 12104. The pedestrian is recognized by, for example, a procedure for extracting feature points in the captured images of the imaging parts 12101 to 12104 serving as infrared cameras and a procedure for determining whether or not the object is a pedestrian by performing pattern matching processing on a series of feature points indicating the outline of the object. When the microcomputer 12051 determines that there is a pedestrian in the captured images of the imaging parts 12101 to 12104, and hence recognizes the pedestrian, the sound-image output part 12052 controls the display part 12062 so as to display a square contour line for emphasis superimposed on the recognized pedestrian. Further, the sound-image output part 12052 may also control the display part 12062 so as to display an icon or the like representing the pedestrian at a desired position.

An example of the vehicle control system to which the technology according to the present disclosure can be applied has been described above. The technology according to the present disclosure can be applied to the imaging part 12031 and the like, for example, out of the configurations described above.

Note that the present technology can also employ the following configurations.

(1)

A photodetection device, including:
a first light source;
a second light source having a characteristic different from a characteristic of the first light source;
a housing that houses the first light source and the second light source;
a first photosensor that detects first reflected light that is first light emitted from the first light source and reflected by an object located outside the housing; and
a second photosensor that detects second reflected light that is second light emitted from the second light source and reflected by a first member located inside the housing.

(2)

The photodetection device according to (1), in which a wavelength of the second light is different from a wavelength of the first light.

(3)

The photodetection device according to (1) or (2), in which
the first light source is a vertical-cavity surface-emitting laser (VCSEL), and
the second light source is a light-emitting diode (LED).

(4)

The photodetection device according to (1) or (2), in which drive signals of the first light source and the second light source are activated at different timings.

(5)

The photodetection device according to any one of (1) to (4), further including: a first pixel circuit that performs analog-to-digital (AD) conversion on a first pixel signal of a pixel in the first photosensor and outputs a digital signal of the first pixel signal; and
a second pixel circuit that holds a voltage value of a second pixel signal of a pixel in the second photosensor and outputs the voltage value of the second pixel signal as an analog signal.

(6)

The photodetection device according to (5), in which the photodetection device further includes a controller that sets a bias voltage based on the analog signal to the first photosensor at a time of detecting the first reflected light.

(7)

The photodetection device according to (6), in which
the first light source and the second light source alternately emit the first light and the second light, and
the controller sets the bias voltage to be applied when the first light emitted next is detected on the basis of the analog signal obtained by the second light.

(8)

The photodetection device according to (6) or (7), in which the controller sets the bias voltage during a period when the digital signal of the first pixel signal is being output.

(9)

The photodetection device according to any one of (6) to (8), in which the controller sets the bias voltage to be applied when the first light emitted next from the first light source is detected, after the first light source emits the first light and before the second light source emits the second light.

(10)

The photodetection device according to any one of (1) to (9), in which the first light source and the second light source emit the first light and the second light simultaneously.

(11)

The photodetection device according to any one of (6) to (8), in which the controller sets the bias voltage to be applied when the first light is detected, after the second light source emits the second light and before the first light source emits the first light.

(12) The photodetection device according to any one of (1) to (11), further including a filter that is provided in the housing and allows light in a predetermined frequency band of the first reflected light to pass through the first photosensor,
in which the first member is the filter.

(13)

The photodetection device according to (12), in which
a transmittance of the first light through the filter is higher than a transmittance of the second light through the filter, and
a reflectance of the first light from the filter is lower than a reflectance of the second light from the filter.

(14)

The photodetection device according to any one of (1) to (12), in which the first photosensor and the second photosensor are provided on one semiconductor chip.

(15)

The photodetection device according to any one of (1) to (14) further including a wall that is provided between the first light source and the second light source and shields the first light and the second light.

(16)

The photodetection device according to any one of (1) to (13), further including a wall that is provided between the first light source and the second light source and shields the first light and the second light,
in which
the first photosensor and the second photosensor are provided on one semiconductor chip, and
the wall is not provided on the semiconductor chip.

(17)

The photodetection device according to any one of (5) to (16), in which a digital signal of the first pixel signal is used to measure a distance from the first photosensor to the object.

(18)

A photodetection device including:
a first light source;
a second light source having a characteristic different from a characteristic of the first light source;
a housing that houses the first light source and the second light source;
a first photosensor that detects first reflected light of first light emitted from the first light source;
a second photosensor that detects second reflected light of second light emitted from the second light source; and
a controller that sets a bias voltage to be applied to the first photosensor when the first reflected light is detected, on the basis of a voltage value of a second pixel signal from the second photosensor.

(19)

The photodetection device according to (18), further including:
a first pixel circuit that performs AD conversion on a first pixel signal of the first photosensor and outputs a digital signal of the first pixel signal; and
a second pixel circuit that holds a voltage value of a second pixel signal of the second photosensor and outputs the voltage value of the second pixel signal as an analog signal.

(20)

The photodetection device according to (18) or (19), in which the second photosensor detects second reflected light that is the second light reflected by a first member located inside the housing.

(21)

The photodetection device according to (20), in which in the first member, a transmittance of the first light is higher than a transmittance of the second light, and a reflectance of the first light is lower than a reflectance of the second light.

(22)

The photodetection device according to any one of (18) to (21), further including a wall that is provided between the first light source and the second light source and shields the first light and the second light.

(23)

The photodetection device according to (22), in which
the first photosensor and the second photosensor are provided on one semiconductor chip, and
the wall is not provided on the semiconductor chip.

(24)

The photodetection device according to any one of (18) to (23), in which a digital signal of the first pixel signal is used to measure a distance from the first photosensor to the object.

(25)

A device, comprising:
a first light source configured to emit a first light;
a second light source configured to emit a second light having a first characteristic different from a second characteristic of the first light;
a first light sensor configured to detect first reflected light that is the first light emitted from the first light source and reflected by an object; and
a second light sensor configured to detect second reflected light that is the second light emitted from the second light source and reflected by a first member that is distinct from the object.

(26)

The device according to (25), wherein the first characteristic of the second light is a first wavelength, wherein the second characteristic is a second wavelength, and wherein the first wavelength is different from the second wavelength.

(27)

The device according to any one of (25) or (26), wherein the first light source is a vertical-cavity surface-emitting laser (VCSEL), and the second light source is a light-emitting diode (LED).

(28)

The device according to any one of (25) to (27), wherein drive signals of the first light source and the second light source are activated at different timings.

(29)

The device according to any one of (25) to (28), further comprising:
a first pixel circuit configured to convert a first pixel signal of a pixel in the first light sensor into a digital signal based on the first pixel signal; and
a second pixel circuit configured to hold a voltage value of a second pixel signal of a pixel in the second light sensor, and output the voltage value of the second pixel signal as an analog signal.

(30)

The device according to (29), wherein the digital signal based on the first pixel signal is used to measure a distance from the first light sensor to the object.

(31)

The device according to (29), further comprising a controller configured to apply a bias voltage to the first light sensor in response to detecting the first reflected light, the bias voltage based on the analog signal.

(32)

The device according to (31), wherein the first light source and the second light source are configured to alternately emit the first light and the second light, and the controller is configured to apply the bias voltage when the first reflected light is next detected.

(33)

The device according to (31), wherein the digital signal is output during a period of time, and wherein the controller is configured to apply the bias voltage during the period of time.

(34)

The device according to (31), wherein the controller is configured to apply the bias voltage when the first reflected light is next detected, after the first light source emits the first light and before the second light source emits the second light.

(35)

The device according to (31), wherein the controller is configured to apply the bias voltage when the first reflected light is detected, after the second light source emits the second light and before the first light source emits the first light.

(36)

The device according to any one of (25) to (35), further comprising:
a housing including the first light source, the second light source, the first light sensor,
the second light source, and the first member,
wherein the object is external to the housing.

(37)

The device according to any one of (25) to (36), further comprising a filter configured to allow the first reflected light in a predetermined frequency band to pass through the filter,
wherein the first member is the filter.

(38)

The device according to (37), wherein
a first transmittance of the first light through the filter is higher than a second transmittance of the second light through the filter, and
a first reflectance of the first light from the filter is lower than a second reflectance of the second light from the filter.

(39)

The device according to any one of (25) to (38), wherein the first light sensor and the second light sensor are disposed on one semiconductor chip.

(40)

The device according to any one of (25) to (39), further comprising a wall between the first light source and the second light source and the wall shields the first light source from the second light emitted by the second light source.

(41)

The device according to (40),
wherein the first light sensor and the second light sensor are disposed on one semiconductor chip, and the wall is disposed separately from the one semiconductor chip.

(42)

A device comprising:
a first light source configured to emit a first light;
a second light source configured to emit a second light having a first characteristic different from a second characteristic of the first light;
a first light sensor configured to detect first reflected light of the first light emitted from the first light source;
a second light sensor configured to detect second reflected light of the second light emitted from the second light source; and
a controller configured to apply a bias voltage to the first light sensor when the first reflected light is detected, on a basis of a voltage value of a second pixel signal from the second light sensor.

(43) The device according to (42), further comprising:
a first pixel circuit configured to convert a first pixel signal of the first light sensor into a digital signal; and
a second pixel circuit configured to hold the voltage value of the second pixel signal of the second light sensor, and output the voltage value of the second pixel signal as an analog signal.

(44)

The device according to (43), wherein the digital signal is used to measure a distance from the first light sensor to an object.

(45)

The device according to any one of (42) to (44), wherein the second light sensor is configured to detect the second reflected light that is the second light reflected by a first fixed member.

(46)

The device according to (45), wherein, in the first fixed member, a first transmittance of the first light is higher than a second transmittance of the second light, and a first reflectance of the first light is lower than a second reflectance of the second light.

(47)

The device according to any one of (42) to (46), further comprising a wall that is disposed between the first light source and the second light source, wherein the wall shields the first light source from the second light of the second light source. Note that the present disclosure is not limited to the above-described embodiments, and various modifications can be made without departing from the gist of the present disclosure. Further, the effects described in the present description are merely examples and are not limited, and other effects may be provided.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

23 Distance measuring module
10 Support substrate
20 Housing
31, 35 Light source part
32, 33 Lens
34 Distance measuring sensor
36 Light shielding wall
40 Light source driver
60 Diffractive optical element (DOE)
90 Optical filter
43a First photosensor
43b Second Photosensor

1. A device, comprising:
a first light source configured to emit a first light;
a second light source configured to emit a second light having a first characteristic different from a second characteristic of the first light;
a first light sensor configured to detect first reflected light that is the first light emitted from the first light source and reflected by an object; and
a second light sensor configured to detect second reflected light that is the second light emitted from the second light source and reflected by a first member that is distinct from the object.

2. The device according to claim 1, wherein the first characteristic of the second light is a first wavelength, wherein the second characteristic is a second wavelength, and wherein the first wavelength is different from the second wavelength.

3. The device according to claim 1, wherein
the first light source is a vertical-cavity surface-emitting laser (VCSEL), and
the second light source is a light-emitting diode (LED).

4. The device according to claim 1, wherein drive signals of the first light source and the second light source are activated at different timings.

5. The device according to claim 1, further comprising:
a first pixel circuit configured to convert a first pixel signal of a pixel in the first light sensor into a digital signal based on the first pixel signal; and
a second pixel circuit configured to
hold a voltage value of a second pixel signal of a pixel in the second light sensor, and
output the voltage value of the second pixel signal as an analog signal.

6. The device according to claim 5, wherein the digital signal based on the first pixel signal is used to measure a distance from the first light sensor to the object.

7. The device according to claim 5, further comprising a controller configured to apply a bias voltage to the first light sensor in response to detecting the first reflected light, the bias voltage based on the analog signal.

8. The device according to claim 7, wherein
the first light source and the second light source are configured to alternately emit the first light and the second light, and the controller is configured to apply the bias voltage when the first reflected light is next detected.

9. The device according to claim 7, wherein the digital signal is output during a period of time, and wherein the controller is configured to apply the bias voltage during the period of time.

10. The device according to claim 7, wherein the controller is configured to apply the bias voltage when the first reflected light is next detected, after the first light source emits the first light and before the second light source emits the second light.

11. The device according to claim 7, wherein the controller is configured to apply the bias voltage when the first reflected light is detected, after the second light source emits the second light and before the first light source emits the first light.

12. The device according to claim 1, further comprising:
a housing including the first light source, the second light source, the first light sensor, the second light source, and the first member,
wherein the object is external to the housing.

13. The device according to claim 1, further comprising a filter configured to allow the first reflected light in a predetermined frequency band to pass through the filter,
wherein the first member is the filter.

14. The device according to claim 13, wherein
a first transmittance of the first light through the filter is higher than a second transmittance of the second light through the filter, and
a first reflectance of the first light from the filter is lower than a second reflectance of the second light from the filter.

15. The device according to claim 1, wherein the first light sensor and the second light sensor are disposed on one semiconductor chip.

16. The device according to claim 1, further comprising a wall between the first light source and the second light source and the wall shields the first light source from the second light emitted by the second light source.

17. The device according to claim 16,
wherein
the first light sensor and the second light sensor are disposed on one semiconductor chip, and
the wall is disposed separately from the one semiconductor chip.

18. A device comprising:
a first light source configured to emit a first light;
a second light source configured to emit a second light having a first characteristic different from a second characteristic of the first light;
a first light sensor configured to detect first reflected light of the first light emitted from the first light source;
a second light sensor configured to detect second reflected light of the second light emitted from the second light source; and
a controller configured to apply a bias voltage to the first light sensor when the first reflected light is detected, on a basis of a voltage value of a second pixel signal from the second light sensor.

19. The device according to claim 18, further comprising:
a first pixel circuit configured to convert a first pixel signal of the first light sensor into a digital signal; and
a second pixel circuit configured to hold the voltage value of the second pixel signal of the second light sensor, and
output the voltage value of the second pixel signal as an analog signal.

20. The device according to claim 19, wherein the digital signal is used to measure a distance from the first light sensor to an object.

21. The device according to claim 18, wherein the second light sensor is configured to detect the second reflected light that is the second light reflected by a first fixed member.

22. The device according to claim 21, wherein, in the first fixed member, a first transmittance of the first light is higher than a second transmittance of the second light, and a first reflectance of the first light is lower than a second reflectance of the second light.

23. The device according to claim 18, further comprising a wall that is disposed between the first light source and the second light source, wherein the wall shields the first light source from the second light of the second light source.
